(19) United States
(12) Patent Application Publication
(10) Pub. No.: US 2012/0207989 A1
(43) Pub. Date: Aug. 16, 2012

(54) MULTILAYERED CORE BOARD WITH ENHANCED NAIL-PULL STRENGTH

(75) Inventors: Yufeng XU, Gurnee, IL (US); Renee WEINBERGER, Waukegan, IL (US)

(73) Assignee: UNITED STATES GYPSUM COMPANY, Chicago, IL (US)

(21) Appl. No.: 13/335,396

(22) Filed: Dec. 22, 2011

Related U.S. Application Data
(60) Provisional application No. 61/426,363, filed on Dec. 22, 2010.

(51) Int. Cl. B32B 7/02; B32B 38/00; B05D 1/38

(52) U.S. Cl. 428/213; 427/372.2; 156/39; 427/379; 428/218

(57) ABSTRACT

Disclosed herein are multilayered core cementitious boards with increased nail-pull resistance. The boards can comprise two or more layers of cementitious compositions, where each layer can be a different density. Methods of making the multilayered core boards are also disclosed. The methods include having a layer of cementitious composition partially set prior to applying the next layer.

### CROSS-REFERENCE TO RELATED APPLICATION

This patent application claims the benefit of U.S. Provisional Patent Application No. 61/426,363, filed Dec. 22, 2010, which is hereby incorporated by reference herein in its entirety.

### BACKGROUND OF THE INVENTION

Wallboard often comprises a core, e.g., comprising set gypsum, sandwiched between two sheets of facer material, e.g., paper, mat, or the like. An ideal wallboard should have mechanical properties that permit it to withstand the forces encountered during manufacture, transport, installation, and use. Two important strength properties for wallboard are flexural strength and nail-pull strength/resistance. Flexural strength is mainly a function of the tensile strength of the facer material and has little to do with the core structure/strength. Nail-pull strength is the ability of board products to resist nail pull-through. It can be evaluated by determining the load required to push a standard nail head through the board and is a function of the facer material strength and the core strength. Normally the higher the board core density, the higher the nail-pull strength. Nail-pull strength is in most cases the limiting factor in reducing the board weight for ½″ thick wallboard.

There is a need in the art to produce wallboard with reduced board weight while maintaining suitable nail pull strength of the board (e.g., as set forth by ASTM).

### BRIEF SUMMARY OF THE INVENTION

In one aspect, the present invention provides a board comprising, consisting essentially of, or consisting of a multi-layer core comprising, consisting essentially of, or consisting of a first cementitious layer having a first density and a first thickness, and a second cementitious layer having a second density and a second thickness. The first density is higher than the second density, and the ratio of the first thickness to the second thickness is from about 1:1 to about 1:3.

In another aspect, the present invention also provides a board comprising, consisting essentially of, or consisting of a multi-layer core comprising, consisting essentially of, or consisting of a first cementitious layer having a first density and a first thickness and a second cementitious layer having a second density and a second thickness. The first density is higher than the second density, and the nail pull resistance of the board according to ASTM C473, Method B is higher in comparison to board comprising, consisting essentially of, or consisting of a core consisting of the second cementitious layer having a thickness substantially equal to the first thickness plus the second thickness and a density substantially equal to the second density.

In another aspect, the present invention further provides a board comprising, consisting essentially of, or consisting of a multi-layer core comprising, consisting essentially of, or consisting of a first cementitious layer having a first density, and a second cementitious layer having a second density. The board core has a composite density based on all layers of the core. The first density is higher than the second density. The composite density is no more than about 45 lbs/ft³, and the board has a minimum nail pull resistance according to ASTM C473, Method B of about 77 lbs of force.

In another aspect, the present invention provides a method of manufacturing layered board, comprising, consisting essentially of, or consisting of providing facing material; applying on the facing material a first cementitious composition having a first density, to form a first core layer; allowing the first core layer to at least partially set; and applying on the first core layer a second cementitious composition having a second density, to form a second core layer. The first density is higher than the second density, and the partial setting of the first layer conforms to the level of setting as described in ASTM C472 at 10.3.1 or until the first layer is sufficiently set so that wash-out of the first layer is substantially prevented when the second layer is applied.

In yet another aspect, the present invention also provides a method for manufacturing a three-layer core board, comprising the above method for manufacturing a two-layer core board and further comprising, consisting essentially of, or consisting of allowing the second layer to partially set; and applying on the second core layer a third cementitious composition having a third density to form a third core layer. The partial setting of the second layer conforms to the level of setting as described in ASTM C472 at 10.3.1 or until the second layer is sufficiently set so that wash-out of the second layer is substantially prevented when the third layer is applied.

### BRIEF DESCRIPTION OF THE DRAWINGS

FIG. 1 schematically illustrates a cross-sectional view of an embodiment of a cementitious board with one core layer (not to scale).

FIG. 2 schematically illustrates a cross-sectional view of an embodiment of a cementitious board with two core layers in accordance with the present invention (not to scale).

FIG. 3 schematically illustrates a cross-sectional view of an embodiment of a cementitious board with three core layers in accordance with the present invention (not to scale).

### DETAILED DESCRIPTION OF THE INVENTION

The present invention is predicated on the surprising and unexpected discovery that the nail-pull strength of a board can be increased using two or more core layers of cementitious compositions within the board. Advantageously, the present invention allows for maintained or even enhanced board strength at lower product weights.

Wallboard is conventionally made with a uniform core structure, i.e., the core of the board comprises a single core layer of a cementitious composition which has a uniform density. For example, core uniformity is described in, e.g., U.S. Pat. No. 5,683,635. Typically, a facing material (e.g., paper or a mat) is placed on either side of the core to form a sandwich structure as is known in the art. Some board products include an ultra-thin “skim coat” layer between the core and one or both facing materials, but such skim coats are mainly for improving the bonding between the core and the facer material (also referred to herein as facing material) and do not themselves add to the nail-pull resistance of the product. The skim coat bonds the facing material to the core, and it is through this bonding that nail pull resistance is improved (i.e., by associating the facing material with the core and preventing the facing material from detaching from the core).

The present inventors have discovered that the failure zone for nail pull resistance is in the region of the board core adjacent to the location of the facing material. In accordance with the present invention, a higher density core layer (and/or a core layer with higher strength, e.g., due to the addition of strength additives) is provided adjacent to (e.g., directly or indirectly under) an inner surface of the facing material, beyond that of a simple skim coat, which unexpectedly affords increased nail-pull resistance to a multilayered board (“core” being referred to herein as that part of the board that does not include the skim coat(s) or facing material(s)). Surprisingly, board according to the invention is effective and advantageous even though it has a non-uniform core, e.g., in view of its having a lower density core layer and a higher density core layer. The lower density core layer can provide structural support while keeping the board weight down, whereas the higher density core layer can provide enhanced nail-pull resistance.

Nail-pull resistance is a well-understood term in the art. Lesser damage caused by the nail as it is inserted into the board equates into higher nail-pull resistance. A lower nail-pull resistance can be due to the board failing, e.g., cracks forming within the core. The present inventors have found that nail-pull testing failure in the core happens on the surface immediately beneath the facer material. The bulk of the core is actually not affected. Therefore, a strong shear resistant surface core layer (e.g., having higher density and/or more strength additives) in the core will provide the necessary load-bearing capacity required to meet, e.g., the ASTM nail-pull specification for the board. As long as the facing core layer (the core layer that is adjacent to the facer material) does not break, the strength requirement for any other core layer will be significantly lower than that of a single-layer board core since the load from the nail head will be distributed to a much larger area beneath the strong facing core layer. Other core layers can then, e.g., be made with more foam and/or with fewer strength additives to reduce the board weight and/or save on production costs. For example, the other core layers can be made to have a density that is lower than conventional boards, wherein the facing core layer provides the necessary strength characteristics, such as nail pull resistance. Alternatively, the other core layers can possess desirable strength characteristics yet be ultralight, for example, made according to U.S. Patent Application Publication Nos. 2007/0048490 and/or 2008/0090068, each of which is incorporated by reference herein in its entirety.

The weight of a board that is necessary for a given function is due to many factors. For instance, for conventional boards, in order for a board to accept greater load, the density and thus the weight of the board must be higher than if the board is to accept a lower load. Also, for greater flexural strength, facing material of greater tensile strength can be used. For greater nail-pull resistance, the density of the core of a board can be uniformly increased since the greater the density, the greater the nail-pull resistance. The board of the present invention, however, allows for the core to be of two or more layers, providing surprising nail-pull resistance without having to uniformly increase the density of the core. By providing two or more core layers, the board of the present invention provides at least one core layer of a greater density and at least one core layer of a lower density. The board of the present invention allows for a board having a weight similar to the board having only the one core layer of a lower density but with a nail-pull resistance that is surprisingly higher than the board having only the one core layer of a lower density.

The present invention provides a board comprising, consisting essentially of, or consisting of a multi-layer core comprising, consisting essentially of, or consisting of a first cementitious layer having a first density and a first thickness, and a second cementitious layer having a second density and a second thickness. The first density is higher than the second density, and the ratio of the first thickness to the second thickness is from about 1:1 to about 1:3.

The present invention also provides a board comprising, consisting essentially of, or consisting of a multi-layer core comprising, consisting essentially of, or consisting of a first cementitious layer having a first density and a first thickness and a second cementitious layer having a second density and a second thickness. The first density is higher than the second density, and the nail pull resistance of the board according to ASTM C473, Method B is higher in comparison to board comprising, consisting essentially of, or consisting of a core consisting of the second cementitious layer having a thickness substantially equal to the first thickness plus the second thickness and a density substantially equal to the second density.

The present invention further provides a board comprising, consisting essentially of, or consisting of a multi-layer core comprising, consisting essentially of, or consisting of a first cementitious layer having a first density, and a second cementitious layer having a second density. The board core has a composite density based on all layers of the core. The first density is higher than the second density. The composite density is no more than about 45 lbs/ft³, and the board has a minimum nail pull resistance according to ASTM C473, Method B of about 77 lbs of force.

The present invention provides a board with any combination of features of the three preceding paragraphs above. As a non-limiting example, the board can have a ratio of first thickness to second thickness from about 1:1 to about 1:3 and a composite density of no more than about 45 lbs/ft³. The combination of features are appropriate where the nail pull resistance of the multilayered board is improved over conventional board.

The ASTM C473 contemplated for the present invention is C473-10. ASTM C473 is entitled, “Standard Test Methods for Physical Testing of Gypsum Panel Products.” The standard includes two methods, one using shot machines (Method A) and one using universal test machines (Method B). The multilayered core board of the present invention may show an improved nail pull resistance over a single layer core board using either Method A or Method B.

The composite density of the core is the overall density when all layers of the core are taken together. As is known in the art, density is calculated as mass (or sometimes weight) per volume. Each core layer has a density which only takes into account the mass (or weight) of that layer and the volume of that layer. For the composite density, the masses (or weights) of every core layer is summed, and the total mass (or weight) is divided by the overall volume of the core (e.g., the sum of the volumes of the individual layers). In an embodiment, the present invention also provides a board comprising, consisting essentially of, or consisting of a multi-layer core comprising, consisting essentially of, or consisting of a first cementitious layer having a first density and a first thickness and a second cementitious layer having a second density and a second thickness. The first density is higher than the second density, and the nail pull resistance of the board according to ASTM C473, Method B is higher in comparison to board comprising, consisting essentially of, or consisting of a core consisting of the second cementitious layer having a thickness substantially equal to the first thickness plus the second thickness and a density substantially equal to the composite density of the multi-layered board.

In one embodiment, the present invention provides a layered cementitious board comprising, consisting essentially of, or consisting of a first core layer and a second core layer. The first core layer comprises, consists essentially of, or consists of a first set cementitious composition having a first density and the second core layer comprises, consists essentially of, or consists of a second set cementitious composition having a second density. The first density is higher than the second density. The first core layer provides increased nail-pull resistance when the first core layer is covered with a facer material and a nail punctures the facer material and the first core layer. The increased nail-pull resistance of the layered board is compared to the nail-pull resistance of a board having a single core layer of a set cementitious composition covered with the same facer material as the multilayered board, where the nail punctures the facer material and the single core layer of cementitious composition, and the single core layer has the same cementitious composition and density as the second core layer of the layered board and has substantially the same thickness as the first and second core layers of the layered board taken together.

Cementitious compositions include gypsum, which is calcium sulfate dihydrate (also “set gypsum” or “hydrated gypsum”). Gypsum can be formed from calcium sulfate anhydrite, calcium sulfate α-hemihydrate, calcium sulfate β-hemihydrate, and natural, synthetic or chemically modified calcium sulfate hemihydrate, and mixtures thereof. In one aspect, the gypsum is formed from calcined gypsum (stucco), such as in the form of calcium sulfate alpha hemihydrate, calcium sulfate beta hemihydrate, and/or calcium sulfate anhydrite. The calcined gypsum can be fibrous in some embodiments and nonfibrous in others. The cementitious composition can include other ingredients as discussed herein.

As described below, the use of foaming agents can be used to achieve various densities of the core layers. In some embodiments, the water:stucco ratio of a gypsum-containing composition can be varied to facilitate obtaining different densities. For example, a lower water to stucco ratio for a given volume results in a higher density gypsum-containing composition. In some embodiments, the gypsum-containing composition of the first core layer is formed from a composition with a water to stucco ratio of from about 0.7 to about 0.8.

The core layers of the present invention can have various densities. In some embodiments, for a two-layered or three-layered core board as described herein, the density of the first core layer can be from about 35 lbs/ft³ to about 70 lbs/ft³. The density can be, e.g., as listed in the table below. In the table, an “X” represents the range “from [corresponding value in first row] to [corresponding value in first column].” For example, the first “X” is the range “from about 35 lbs/ft³ to about 40 lbs/ft³.”

TABLE 1

| | about 35 | about 40 | about 45 | about 50 | about 55 | about 60 | about 65 |
|---|---|---|---|---|---|---|---|
| | lbs/ft³ | lbs/ft³ | lbs/ft³ | lbs/ft³ | lbs/ft³ | lbs/ft³ | lbs/ft³ |
| about 40 | X | | | | | | |
| lbs/ft³ | | | | | | | |
| about 45 | X | X | | | | | |
| lbs/ft³ | | | | | | | |
| about 50 | X | X | X | | | | |
| lbs/ft³ | | | | | | | |
| about 55 | X | X | X | X | | | |
| lbs/ft³ | | | | | | | |
| about 60 | X | X | X | X | X | | |
| lbs/ft³ | | | | | | | |
| about 65 | X | X | X | X | X | X | |
| lbs/ft³ | | | | | | | |
| about 70 | X | X | X | X | X | X | X |
| lbs/ft³ | | | | | | | |

Thus, the density can have a range between any aforementioned endpoints.

In some embodiments, the density of the second core layer can be from about 25 lbs/ft³ to about 40 lbs/ft³. The density can be, e.g., as listed in the table below. In the table, an “X” represents the range “from [corresponding value in first row] to [corresponding value in first column].” For example, the first “X” is the range “from about 25 lbs/ft³ to about 30 lbs/ft³.”

TABLE 2

| | about | about | about |
|---|---|---|---|
| | 25 lbs/ft³ | 30 lbs/ft³ | 35 lbs/ft³ |
| about | X | | |
| 30 lbs/ft³ | | | |
| about | X | X | |
| 35 lbs/ft³ | | | |
| about | X | X | X |
| 40 lbs/ft³ | | | |

Thus, the density can have a range between any aforementioned endpoints.

In some embodiments, for a three-layered core board, the density of the third core layer can be from about 35 lbs/ft³ to about 70 lbs/ft³ and can be within the ranges as described for the first core layer, e.g., as in Table 1 above.

In some embodiments, the composite density of the board is no more than about 45 lbs/ft³. The density can be, e.g., as listed in the table below. In the table, an “X” represents the range “from [corresponding value in first row] to [corresponding value in first column].” For example, the first “X” is the range “from about 10 lbs/ft³ to about 15 lbs/ft³.”

TABLE 3

| | about 10 | about 15 | about 20 | about 25 | about 30 | about 35 | about 40 |
|---|---|---|---|---|---|---|---|
| | lbs/ft³ | lbs/ft³ | lbs/ft³ | lbs/ft³ | lbs/ft³ | lbs/ft³ | lbs/ft³ |
| about 15 | X | | | | | | |
| lbs/ft³ | | | | | | | |
| about 20 | X | X | | | | | |
| lbs/ft³ | | | | | | | |
| about 25 | X | X | X | | | | |
| lbs/ft³ | | | | | | | |
| about 30 | X | X | X | X | | | |
| lbs/ft³ | | | | | | | |
| about 35 | X | X | X | X | X | | |
| lbs/ft³ | | | | | | | |
| about 40 | X | X | X | X | X | X | |
| lbs/ft³ | | | | | | | |
| about 45 | X | X | X | X | X | X | X |
| lbs/ft³ | | | | | | | |

Thus, the density can have a range between any aforementioned endpoints.

In accordance with the present invention, any suitable facer material can be used. For example, paper sheet, such as Manila paper or kraft paper, can be used as the facer material in some embodiments. In some embodiments where the board may be exposed to a substantial amount of moisture, suitable facer material includes a mat, such as a fibrous mat. As used herein, the term “mat” includes mesh materials. Fibrous mats can include any suitable fibrous mat material. For example, in some embodiments, the facer material can be a mat made from glass fiber, polymer fiber, mineral fiber, organic fiber, or the like or combinations thereof. Polymer fibers include, but are not limited to, polyamide fibers, polyaramide fibers, polypropylene fibers, polyester fibers (e.g., polyethylene teraphthalate (PET)), polyvinyl alcohol (PVOH), and polyvinyl acetate (PVAc). Examples of organic fibers include cotton, rayon, and the like. In some embodiments of the multilayered core boards of the present invention, facer materials can be placed solely on the surfaces of the boards (i.e., not used at the interfaces between core layers). For example, the first, second, and/or third core layers of the boards of the present invention are not separated by any such materials, including meshes or scrims.

Fibrous mats for use with board of the present invention are commercially available in many forms, such as woven or non-woven mats. Non-woven mats can comprise fibers bound together by a binder. The binder can be any binder typically used in the mat industry, such as urea formaldehyde, melamine formaldehyde, stearated melamine formaldehyde, polyester, acrylics, polyvinyl acetate, urea or melamine formaldehyde modified or blended with polyvinyl acetate or acrylic, styrene acrylic polymers, and the like, or combinations thereof. The fibers of the mat can be hydrophobic or hydrophilic. They can also be coated or uncoated. Selecting a suitable type of fibrous mat will depend, in part, on the type of application in which the board is to be used. For example, when the board is used for applications that require water resistance, hydrophobic fibers should be used in the fibrous mat.

In embodiments where there are two facer materials, the second facer material can be the same as the first facer material, both in material and orientation relative to the core, or can have sufficiently similar expansion and contraction properties, and/or bond characteristics as the first facer material, such that warping of the board is reduced or eliminated. In embodiments where the second facer material is the same as the first facer material, it should be understood that the first and second facer materials can be provided, for example, in separate rolls or by a single continuous piece of material, for example, by folding a single piece of facer material such that it wraps around the core.

The present invention also provides embodiments of a three-layer core board. Such a board can include a two-layer core board (with a first core layer and a second core layer as described above) having a third core layer, wherein the third core layer comprises, consists essentially of, or consists of a third set cementitious composition having a third density, wherein the third density is higher than the second density. Embodiments of the three-layer core board include a board having a core with the structure of a dense layer, a less dense layer, and a dense layer or a dense layer, a less dense layer, and a least dense layer. Any combinations of core layers are possible in the multilayered core board, so long as the board affords improved nail-pull resistance compared to, e.g., a one-layer core board with the same facing material and a core of the same cementitious composition and density of the, e.g., least dense core layer of the multilayer board. Thus, an embodiment of the present invention includes where the second core layer, having the lowest density, is in-between the first core layer and the third core layer, the first core layer and the third core layer each having higher densities than the second core layer. Another embodiment includes where the third core layer density is the same as the first core layer density. Another embodiment includes where the third core layer density is different than the first core layer density. Additionally, the cementitious compositions of the first core layer and the third core layer of the core can be the same or different.

The present invention further provides a three-layer core board where the nail pull resistance of the board according to ASTM C473, Method B is higher in comparison to board comprising, consisting essentially of, or consisting of a core consisting of the second cementitious layer having a thickness substantially equal to the sum of the thicknesses of the first, second, and third layers. So long as the nail-pull resistance is improved for the multilayered core board over a one-layer core board as stated above, any suitable ratio of thickness of the first core layer to the second core layer in a two-layer core board, or the first core layer to the second core layer to the third core layer in a three-layer core board, is acceptable. In some embodiments of a two-layer core board of the present invention, the ratio of thickness of the first core layer to the second core layer is from about 1:1 to about 1:3, e.g., 1:1, 1:2, or 1:3. Therefore, the ratio of the core layers in a two-layer board can have a range bounded by any two of the aforementioned endpoints.

In some embodiments of a three-layer core board of the present invention, the ratio of thickness of the first core layer to the second core layer to the third core layer is from about 1:1:1 to about 1:3:1, e.g., 1:1:1, 1:2:1, or 1:3:1. Therefore, the ratio of the core layers in a three-layer board can have a range bounded by any two of the aforementioned endpoints.

In some embodiments, the layered board of the present invention, when at about ½″ in thickness, has a total board weight from about 1100 lb/msf to about 1500 lb/msf. The weight can be, e.g., as listed in the table below. In the table, an “X” represents the range “from [corresponding value in first row] to [corresponding value in first column].” For example, the first “X” is the range “from about 1100 lbs/msf to about 1150 lbs/msf.”

TABLE 4

| | about 1100 | about 1150 | about 1200 | about 1250 | about 1300 | about 1350 | about 1400 | about 1450 |
|---|---|---|---|---|---|---|---|---|
| | lbs/msf | lbs/msf | lbs/msf | lbs/msf | lbs/msf | lbs/msf | lbs/msf | lbs/msf |
| about 1150 | X | | | | | | | |
| lbs/msf | | | | | | | | |
| about 1200 | X | X | | | | | | |
| lbs/msf | | | | | | | | |
| about 1250 | X | X | X | | | | | |
| lbs/msf | | | | | | | | |
| about 1300 | X | X | X | X | | | | |
| lbs/msf | | | | | | | | |
| about 1350 | X | X | X | X | X | | | |
| lbs/msf | | | | | | | | |
| about 1400 | X | X | X | X | X | X | | |
| lbs/msf | | | | | | | | |
| about 1450 | X | X | X | X | X | X | X | |
| lbs/msf | | | | | | | | |
| about 1500 | X | X | X | X | X | X | X | X |
| lbs/msf | | | | | | | | |

Thus, the weight can have a range between any aforementioned endpoints.

The board can have a minimum nail-pull resistance of from about 50 to about 150 lbs. The nail-pull can be, e.g., as listed in the table below. In the table, an “X” represents the range “from [corresponding value in first row] to [corresponding value in first column].” For example, the first “X” is the range “from about 50 lbs to about 60 lbs.”

TABLE 5

| | about | about | about | about | about | about | about | about | about | about |
|---|---|---|---|---|---|---|---|---|---|---|
| | 50 lbs | 60 lbs | 70 lbs | 80 lbs | 90 lbs | 100 lbs | 110 lbs | 120 lbs | 130 lbs | 140 lbs |
| about | X | | | | | | | | | |
| 60 lbs | | | | | | | | | | |
| about | X | X | | | | | | | | |
| 70 lbs | | | | | | | | | | |
| about | X | X | X | | | | | | | |
| 80 lbs | | | | | | | | | | |
| about | X | X | X | X | | | | | | |
| 90 lbs | | | | | | | | | | |
| about | X | X | X | X | X | | | | | |
| 100 lbs | | | | | | | | | | |
| about | X | X | X | X | X | X | | | | |
| 110 lbs | | | | | | | | | | |
| about | X | X | X | X | X | X | X | | | |
| 120 lbs | | | | | | | | | | |
| about | X | X | X | X | X | X | X | X | | |
| 130 lbs | | | | | | | | | | |
| about | X | X | X | X | X | X | X | X | X | |
| 140 lbs | | | | | | | | | | |
| about | X | X | X | X | X | X | X | X | X | X |
| 150 lbs | | | | | | | | | | |

Thus, the nail-pull can have a range between any aforementioned endpoints.

In some embodiments, the two- or three-layer board of the present invention has a weight of 1,300 lb/msf or less, when at about ½″ in thickness, and wherein the board has a nail pull of at least 96 lbs according to ASTM C473, Method B. The present invention also provides for layered board wherein the board has a minimum nail-pull resistance of about 77 lbs for a ½ inch board, such a board may also have a weight of 1,300 lb/msf or less.

The thickness of the core layers can vary for two- and three-layer core boards of the present invention. In one embodiment of the invention, a two-layer core board has a first core layer of ¼ of an inch in thickness. In another embodiment, the first core layer is ⅛ of an inch in thickness. The thickness can be, e.g., as listed in the table below. In the table, an “X” represents the range “from [corresponding value in first row] to [corresponding value in first column].” For example, the first “X” is the range “from about ⅛ in to about 1/7 in.”

TABLE 6

| | about | about | about | about |
|---|---|---|---|---|
| | ⅛ in | 1/7 in | ⅙ in | ⅕ in |
| about | X | | | |
| 1/7 in | | | | |
| about | X | X | | |
| ⅙ in | | | | |
| about | X | X | X | |
| ⅕ in | | | | |
| about | X | X | X | X |
| ¼ in | | | | |

Thus, the thickness can have a range bounded by any two of the aforementioned endpoints.

In another embodiment, a three-layer core board has a first core layer and third core layer together being ¼ of an inch in thickness. In another embodiment, the first core layer and third core layer together are ⅛ of an inch in thickness. The combined thickness can be, e.g., as listed in the table below. In the table, an “X” represents the range “from [corresponding value in first row] to [corresponding value in first column].” For example, the first “X” is the range “from about ⅛ in to about 1/7 in.”

TABLE 7

| | about | about | about | about |
|---|---|---|---|---|
| | ⅛ in | 1/7 in | ⅙ in | ⅕ in |
| about | X | | | |
| 1/7 in | | | | |
| about | X | X | | |
| ⅙ in | | | | |
| about | X | X | X | |
| ⅕ in | | | | |
| about | X | X | X | X |
| ¼ in | | | | |

Thus, the thickness of the first core layer together with the third core layer can have a range bounded by any two of the aforementioned endpoints.

It is contemplated that any combination of nail-pull resistance, ratio of core layer thicknesses, and weight of board can be achieved, so long as the nail-pull resistance is improved, as stated above. For example, the weight of the board can be decreased by decreasing the density of the second core layer while increasing the density of the first core layer. This can also be achieved by increasing the thickness of the first core layer and/or altering the ratio of thicknesses of the layers. Thus, in an embodiment of the present invention, the multilayered board can have a composite density that is equivalent to a single-layer board, wherein the multilayered board has a higher nail-pull resistance. In another embodiment, the multilayered board can have a thickness that is equivalent to a single-layer board, wherein the multilayered board has a higher nail-pull resistance.

Accordingly, it also is contemplated that ratios of parameters are integral to any embodiment of the invention, for example, the ratio of nail pull resistance to dry weight or the ratio of nail pull resistance to density. It is contemplated that any parameter described herein can be further determined as a ratio of any other parameter described herein, either as an individual value based on one value each of two different parameters or as an overall value based on several values each of two different parameters (such as when plotting one value against another to determine a mathematical relationship such as a linear slope). Such ratios can be used to determine the increase in one parameter necessary, e.g., to compensate or allow for the reduction of another parameter, or to determine the limits of reduction in one parameter that still provides acceptable values in another parameter. The tables in the Examples below provide examples of ratios.

Additional embodiments include where any core layer cementitious composition comprises, consists essentially of, or consists of an accelerator, a retarder, an enhancing agent, a strength additive, or any combination thereof. Accelerator materials are commonly used in the production of products to enhance the efficiency of hydration and to control set time. Accelerators are described, for example, in U.S. Pat. Nos. 3,573,947, 3,947,285, and 4,054,461, each of which is incorporated by reference herein in its entirety. Wet gypsum accelerator (WGA), which comprises particles of calcium sulfate dihydrate, water, and at least one additive, is described in U.S. Pat. No. 6,409,825 and in commonly assigned U.S. Patent Application Publication Nos. 2006/0243171 and 2006/0244183, each of which is incorporated by reference herein in its entirety. The use of accelerators may allow for more rapid deposition of core layers during the manufacturing process, e.g., such as that described in more detail below. Faster setting of the core layers of board as described herein may allow the board to be manufactured using manufacturing lines already designed to produce conventional board.

Accelerators can be used to decrease the time required for a layer to become partially set, as described below. Use of accelerators may allow for the boards of the present invention to be manufactured on existing continuous wallboard lines. For example, by increasing the concentration and/or altering the identity of accelerators used, a core layer can be made to partially set quickly in order for another core layer to be added. A higher concentration of accelerator may be used if a three-layer board is manufactured on a line as compared to a two-layer board on the same line so that the middle core layer may partially set in time before the additional layer is applied. Thus, by adjusting the concentration and/or identity of accelerators used, a continuous wallboard line may be used to manufacture the multilayered board of the present invention.

Other suitable additives include, for example, enhancing agents such as phosphonic or phosphate-containing ingredients such as those described in U.S. Pat. No. 6,409,825 and U.S. Patent Application Publication Nos. 2006/0243171 and 2006/0244183, each of which is incorporated by reference herein in its entirety. Suitable additives include compounds selected from the group consisting of an organic phosphonic compound, a phosphate-containing compound, and mixtures thereof. A cementitious composition in accordance with the invention can comprise, consist essentially of, or consist of at least one additive selected from the group consisting of an organic phosphonic compound, a phosphate-containing compound, and mixtures thereof. In addition, it is contemplated that embodiments of the invention can be substantially free of organic phosphonic compounds and/or phosphate-containing compounds as described herein. As used herein, “substantially free” means that the composition of the present invention contains 0 wt. % based on the weight of stucco of additive, or no additive, or an ineffective trace amount of additive.

The organic phosphonic compounds suitable for use in the cementitious compositions of the present invention include those with at least one RPO₃M₂ functional group, where M is a cation, phosphorus, or hydrogen, and R is an organic group. Examples include organic phosphonates and phosphonic acids. Organic polyphosphonic compounds are preferred although organic monophosphonic compounds can be utilized as well. The organic polyphosphonic compounds can include at least two phosphonate salt or ion groups, at least two phosphonic acid groups, or at least one phosphonate salt or ion group and at least one phosphonic acid group. A monophosphonic compound according to the invention can include one phosphonate salt or ion group or at least one phosphonic acid group.

The organic group of the organic phosphonic compounds is bonded directly to the phosphorus atom. The organic phosphonic compounds suitable for use in the invention include, but are not limited to, water soluble compounds characterized by the following structures:

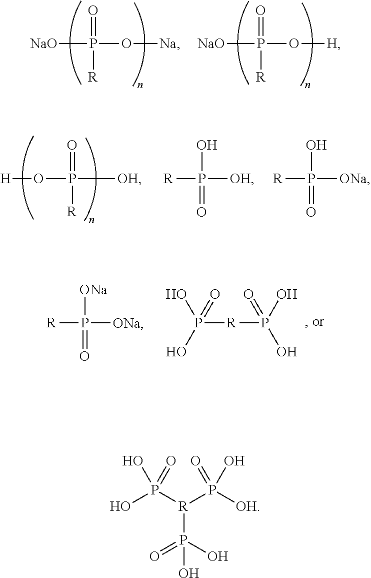

In these structures, R refers to an organic moiety containing at least one carbon atom bonded directly to a phosphorus atom P, and n is a number of from about 1 to about 20, preferably a number of from about 2 to about 10 (e.g., 4, 6, or 8).

Organic phosphonic compounds include, for example, aminotri(methylenephosphonic acid), 1-hydroxyethylidene-1,1-diphosphonic acid, diethylenetriamine penta(methylenephosphonic acid), hexamethylenediamine tetra(methylenephosphonic acid), as well as any suitable salt thereof, such as, for example, potassium salt, sodium salt, ammonium salt, calcium salt, or magnesium salt of any of the foregoing acids, and the like, or combinations of the foregoing salts and/or acids. In some embodiments, DEQUEST™ phosphonates commercially available from Solutia, Inc., St. Louis, Mo., are utilized in the invention. Examples of DEQUEST™ phosphonates include DEQUEST™ 2000, DEQUEST™ 2006, DEQUEST™ 2016, DEQUEST™ 2054, DEQUEST™ 2060S, DEQUEST™ 2066A, and the like. Other examples of suitable organic phosphonic compounds are found, for example, in U.S. Pat. No. 5,788,857, the disclosure of which is incorporated herein by reference herein in its entirety.

Any suitable phosphate-containing compound can be utilized. By way of example, the phosphate-containing compound can be an orthophosphate or a polyphosphate, including, but not limited to, monobasic phosphate salts, such as monoammonium phosphate, monosodium phosphate, monopotassium phosphate, or combinations thereof. A preferred monobasic phosphate salt is monosodium phosphate. Polybasic orthophosphates also can be utilized in accordance with the invention. The phosphate-containing compound can be in the form of an ion, salt, or acid.

Any suitable polyphosphate salt can be used in accordance with the present invention. The polyphosphate can be cyclic or acyclic. Examples of cyclic polyphosphates include trimetaphosphate salts, including double salts, that is, trimetaphosphate salts having two cations. The trimetaphosphate salt can be selected, for example, from sodium trimetaphosphate, potassium trimetaphosphate, calcium trimetaphosphate, lithium trimetaphosphate, ammonium trimetaphosphate, aluminum trimetaphosphate, and the like, or combinations thereof. Sodium trimetaphosphate is a preferred trimetaphosphate salt. Also, any suitable acyclic polyphosphate salt can be utilized in accordance with the present invention. Preferably, the acyclic polyphosphate salt has at least two phosphate units. By way of example, suitable acyclic polyphosphate salts in accordance with the present invention include, but are not limited to, pyrophosphates, tripolyphosphates, sodium hexametaphosphate having from about 6 to about 27 repeating phosphate units, potassium hexametaphosphate having from about 6 to about 27 repeating phosphate units, ammonium hexametaphosphate having from about 6 to about 27 repeating phosphate units, and combinations thereof. Another acyclic polyphosphate salt pursuant to the present invention is commercially available as CALGON™ from Solutia, Inc., St. Louis, Mo., which is a sodium hexametaphosphate having from about 6 to about 27 repeating phosphate units. In addition, the phosphate-containing compound can be in the acid form of any of the foregoing salts. The acid can be, for example, a phosphoric acid or polyphosphoric acid. The phosphate-containing compound can be selected from the group consisting of tetrapotassium pyrophosphate, sodium acid pyrophosphate, sodium tripolyphosphate, tetrasodium pyrophosphate, sodium potassium tripolyphosphate, ammonium polyphosphate, sodium trimetaphosphate, and combinations thereof.

Retarders that can be used in the present invention are known in the art and include Versenex 80 (pentasodium diethylenetriaminepentaacetate), other chelating agents, and straight chain phosphate-containing chemicals. In addition, it is contemplated that embodiments of the invention can be substantially free of retarders. As used herein, “substantially free” means that the composition of the present invention contains 0 wt. % based on the weight of stucco of additive, or no additive, or an ineffective trace amount of additive.

Strength additives are also known in the art and can be added to the compositions of the present invention. Strength additives include starches, for example corn, wheat, potato, or tapioca starches. The starches may be pre-gelatinized starches. Enhancing nail pull resistance can be achieved in a multi-layer core board by having two or more core layers such that the facing core layer has a higher concentration of strength additives than a non-facing core layer. Although the density of the facing core layer may not be different than the non-facing layer(s), the presence of the strength additives can allow for the multi-layered board to have improved nail pull resistance compared to a board with a single layer, the multi-layered board and single layer board having the same facing material and the same overall thickness, and the single layer board comprised of a layer of the non-facing layer of the multi-layered board and having the same overall amount of strength additives as the non-facing layer. In addition, it is contemplated that embodiments of the invention can be substantially free of strength additives as described herein. As used herein, “substantially free” means that the composition of the present invention contains 0 wt. % based on the weight of stucco of additive, or no additive, or an ineffective trace amount of additive.

In embodiments of boards formed according to principles of the present disclosure, and the methods for preparing such boards, the core slurry formulation can include a hydroxyethylated starch. As used herein, a “hydroxyethylated starch” is a native, modified, or treated starch that has been reacted with a suitable reagent to functionalize a portion of the free hydroxyl groups on the starch with hydroxyethyl groups. Hydroxyethylated starches are sometimes referred to as ethylated starches. A starch can be modified or treated, either before or after hydroxyethylation, by, e.g., dextrinization, acid modification, enzymatic modification, mechanical shear, etherification, esterification, cross linking, cationization, and the like, or any combination thereof.

In some embodiments, the hydroxyethylated starch commercially available from Grain Processing Corporation of Muscatine, Iowa, and marketed as COATMASTER® K98F ethylated corn starch can be used. In other embodiments, a hydroxyethylated starch commercially available from PacMoore Products, Hammond, Ind., and marketed as S-Size 30 G can be used. In still other embodiments, another suitable hydroxyethylated starch can be used which comprises a modified corn starch having the following typical analysis: moisture from 10 to 13%, a pH from 5.0 to 7.5, a particle size from 95% through 100 mesh, a specific gravity of about 1.50, a molecular weight of greater than about 10,000 g/mol, and a bulk density of about 35 pcf. In yet other embodiments, other hydroxyethylated starches can be used individually or in combination. See also, U.S. Patent Application Publication No. 2008/0070026. In addition, it is contemplated that embodiments of the invention can be substantially free of hydroxylated starches as described herein. As used herein, “substantially free” means that the composition of the present invention contains 0 wt. % based on the weight of stucco of additive, or no additive, or an ineffective trace amount of additive.

Additional additives can include polyvinyl acetate polymer, a monobasic phosphate, and optionally boric acid. Any suitable polyvinyl acetate type polymer can be used in accordance with the present invention. In particular, the polyvinyl acetate type polymer can be any such polymer that crosslinks, for example, in the presence of a monobasic phosphate or boric acid. In such embodiments, the polyvinyl acetate type polymer can be, for example, polyvinyl acetate, polyvinyl alcohol, polyvinyl acetate copolymer, or a polyvinyl alcohol copolymer because of this cross-linking capability with the other additives. Thus, as defined herein, “polyvinyl acetate type polymer” encompasses, without limitation, polyvinyl alcohols. In this respect, the polymerization of polyvinyl acetate and the subsequent hydrolysis to replace some or all of the acetate substituents on the polymer chain with hydroxyl groups forms polyvinyl alcohol. In some embodiments, mixtures of more than one polyvinyl acetate type polymer can be used. In addition, it is contemplated that embodiments of the invention can be substantially free of the additives as described above. As used herein, “substantially free” means that the composition of the present invention contains 0 wt. % based on the weight of stucco of additive, or no additive, or an ineffective trace amount of additive.

Other suitable additives included in the core layers can be any additives commonly used to produce board. Such additives include, without limitation, structural additives such as mineral wool, perlite, clay, vermiculite, calcium carbonate, polyester, and paper fiber, as well as chemical additives such as foaming agents, fillers, sugar, borates (ulexite, colemanite, etc.) and the like, binders (e.g., starch and latex), colorants, fungicides, biocides, and the like. Examples of the use of some of these and other additives are described, for instance, in U.S. Pat. Nos. 6,342,284; 6,632,550; 6,800,131; 5,643,510; 5,714,001; and 6,774,146; and U.S. Pat. Appl. Pub. Nos. 2004/0231916 A1; 2002/0045074 A1 and 2005/0019618 A1, each of which is incorporated by reference herein in its entirety. In addition, it is contemplated that embodiments of the invention can be substantially free of the additives as described above. As used herein, “substantially free” means that the composition of the present invention contains 0 wt. % based on the weight of stucco of additive, or no additive, or an ineffective trace amount of additive.

The present invention provides a method of manufacturing layered board as described herein, comprising, consisting essentially of, or consisting of providing facing material; applying on the facing material a first cementitious composition having a first density, to form a first core layer; allowing the first core layer to at least partially set; and applying on the first core layer a second cementitious composition having a second density, to form a second core layer. The first density is higher than the second density, and the partial setting of the first layer conforms to the level of setting as described in ASTM C472 at 10.3.1 or until the first layer is sufficiently set so that wash-out of the first layer is substantially prevented when the second layer is applied.

The present invention also provides a method for manufacturing a three-layer core board as described herein, comprising the above method for manufacturing a two-layer core board and further comprising, consisting essentially of, or consisting of allowing the second layer to partially set; and applying on the second core layer a third cementitious composition having a third density to form a third core layer. The partial setting of the second layer conforms to the level of setting as described in ASTM C472 at 10.3.1 or until the second layer is sufficiently set so that wash-out of the second layer is substantially prevented when the third layer is applied.

Without wishing to be bound by theory, the gypsum crystals formed during the setting of the layers may form an interlocking matrix within the layers and at least a portion of the crystals may grow and extend into other layers of the board. For example, gypsum crystals of the second layer may grow and extend into the partially set first layer. Gypsum crystals from the partially set first layer may also grow and extend into the second layer as the first layer fully sets. Growth and extension of crystals between layers increases the overall strength of the multilayered board due to the formation of interlocking gypsum crystals between layers.

Board in accordance with the present invention may be manufactured using principles that are well known in the art. For example, U.S. Pat. No. 7,364,676 discloses a process which includes a continuously moving layer of facer material for receiving the continuous deposition of slurry from a mixer, a mixer for preparing slurry, and a forming station. Manufacture of mat-faced board is described, for example, in co-pending, commonly assigned U.S. Pat. Appl. Pub. Nos. US 2008/0190062, US 2009/0029141, and US 2010/0143682, each incorporated by reference herein in its entirety. Briefly, the process typically involves discharging a facer material onto a conveyor, or onto a forming table that rests on a conveyer, which is then positioned under the discharge conduit (e.g., a gate-canister-boot arrangement as known in the art, or an arrangement as described in U.S. Pat. Nos. 6,494,609 and 6,874,930) of a mixer. As one of ordinary skill in the art will appreciate, board products are typically formed “face down” such that the first facer material serves as the “face” of the board after it is installed. The components of the cementitious composition slurry are fed to the mixer comprising the discharge conduit, where they are agitated to form the slurry. Foam can be added in the discharge conduit (e.g., in the gate as described, for example, in U.S. Pat. Nos. 5,683,635 and 6,494,609). The slurry is discharged onto the facer material. The slurry is spread, as necessary, over the facer material. See, e.g., U.S. Pat. No. 7,364,676. For a multilayered core board, the first core layer can be applied directly onto the facer material, or a skim coat can be applied to the facer material prior to applying. A skim coat is a very thin, very dense layer of a cementitious composition that assists in bonding the facer material to the core layer, as discussed above, the slurry of which also may form the edges of the board, as is described in U.S. Patent Application Publication No. 2010/0247937, which is incorporated by reference herein in its entirety. Briefly, in some embodiments, the slurry for the skim coat is applied to the facing material and then spread on the facing material by a roller. The roller is often narrower than the width of the facing material, such that excess skim slurry collects on the facing material between the ends of the roller and the ends of the facing material. This skim coat slurry forms the edges of the board. Alternatively, separate edge hoses may be used for disposing the edges.

As an example for further describing the board manufacturing process, the wet slurry may be conveyed to a forming station where the slurry is sized to a desired thickness, and to one or more knife sections where it is cut to a desired length to provide a board. It will be appreciated by those skilled in the art that several methods of preparing and depositing slurry are available. These methods may be used for any layer of a multilayered board. The final board with all of the core layers applied is allowed to fully set (harden) completely, and, optionally, excess water is removed using a drying process (e.g., by air-drying or transporting the board through a kiln).

Core layers are allowed to partially set prior to the applying of additional core layers. Partial setting as defined herein conforms to ASTM C472, 10.3.1 or until the layer is sufficiently set so that wash-out of the layer (e.g., first or second) is substantially prevented when the subsequent layer (e.g., second or third) is applied. Wash-out occurs when a layer of slurry, e.g., a skim coat or a core layer, that has been previously applied is washed away by a subsequent layer when the subsequent layer is applied, e.g., using the discharge conduit. Wash-out can occur when the previously applied layer has not set enough, and the force of the subsequently applied slurry as it comes out of the discharge conduit is sufficient to displace the previously applied layer.

The ASTM C472 contemplated for the present invention is ASTM C472-99 (Reapproved 2009). ASTM C472 is entitled, “Standard Test Methods for Physical Testing of Gypsum, Gypsum Plasters and Gypsum Concrete.” ASTM C472 includes a procedure at section 10.3.1 which uses a Vicat apparatus to test the level of setting of gypsum. The ASTM can be similarly used for any cementitious material described herein. The Vicat apparatus uses a needle to penetrate cementitious material. Section 10.3.1 describes setting time being complete when the needle no longer penetrates to the bottom of the material. In accordance with an embodiment of the present invention, the methods of the present invention provide partially set layers such that section 10.3.1 of ASTM C472 is satisfied.

In some embodiments, a second facer material, which can be the same or different from the first facer material, can be applied on top of the core so that the core is sandwiched between the facer materials, as is known in the art. The second facer material generally corresponds with the back of the board when installed. The core is allowed to set or harden while supported by the first facer material, cut to length in one or more steps, inverted as desired, and heated (e.g., in a kiln) to remove excess water, as is well within the skill of the ordinary artisan. The second facer material can be applied on the second core layer of the board of the present invention. The facing material can be applied with a skim coat prior to applying to the core. The second facer material can be applied on the third core layer of the board of the present invention. Such a facing material also can be applied with a skim coat prior to applying to the core.

In some embodiments, any number of the core layers can be formed in a single mixer. For example, if the first and second or first and third core layer slurries are formed in a single mixer, the slurries will largely have the same additives, with the exception of a foam component and/or other additives added to the slurry after it has been extracted from the mixer, or any additives that are added to a layer slurry after it has been extracted from the mixer. Layers of higher density, then, can be foamed less, whereas layers of lower density can be foamed more. Alternatively, the core layer slurries can be formed in different mixers. If separate mixers are used, the additives present in the layer slurries can be different or the same, as desired.

Without limitation to any method of introducing additives, the additives can be introduced during manufacture in any suitable manner, in any suitable location, and in any suitable order. For example, two or more of the additives may be pre-mixed, alone or in combination with other additives or other raw ingredients. Alternatively, each type of additive may be introduced individually during manufacture. In some embodiments, the additives are added in dry form so as not to add excess water into the system. However, if desired, any combination of the additives may be delivered in a fluid medium, such as an aqueous medium (e.g., solution, dispersion, slurry, etc.) such as in embodiments where the additives are added during or after setting, e.g., by spraying, dipping, spin coating, brushing, or rolling (or combinations thereof).

In accordance with the present invention, the location where the additives are introduced may depend on which core layer has the additives added. In some embodiments, the additives are introduced into the pin mixer commonly known in the art. Such an arrangement provides the additives in the slurry for forming the layers of the core. In this respect, in some embodiments, one or more slurries for forming the core layers are extracted from the same pin mixer for mixing the slurry for forming the core, such that inclusion of the additives in the pin mixer provides the additives in all of the layers of the core. It is to be noted that the slurry for forming higher density layers includes less foam than what is in the slurry for forming the less dense core layers e.g., by adding less foam to the slurry at the point of applying, or the foam is “beaten out” such as by way of one or more secondary mixers.

In some embodiments, the additives are introduced into the discharge conduit of the mixer (such as a gate-canister-boot or including volume restrictor and pressure reducer as in U.S. Pat. No. 6,494,609, etc.). This arrangement has utility in embodiments where two or more core layers are present but inclusion of the additives is not desired in all of the layers. In this respect, some core layers will be extracted from the pin mixer before the additives are introduced downstream of the pin mixer in the discharge conduit. It will be appreciated that it is also possible to tailor the distribution of the additives in the core layers by separately introducing the additives into the core layers in this mode of introduction.

In some embodiments, where the additives are not desired in a certain core layer, the additives can be introduced into slurry stream(s) for forming layer(s) after they are extracted from the pin mixer for mixing the slurry for forming the core layer with additives, such as in conduits conveying slurry such as “edge hoses,” or in a secondary mixer, such as is employed to beat out foam. In one aspect, the additives may be introduced in multiple mixer arrangements known in the art. See, e.g., U.S. Pat. No. 5,714,032 and U.S. Pat. Appl. Pub. No. 2004/0134585 A1, each incorporated by reference herein in its entirety.

In some embodiments, the production of board optionally can include vibration of a partially set layer prior to hardening (e.g., prior to applying a subsequent core layer or facing material) to facilitate reduction or elimination of voids in the slurry, if desired. Any suitable vibration technique or device known in the art, such as, for example, variable frequency tables or platform sections can be used. Any suitable vibration technique known in the art can be used. For example, vibration bars, variable frequency tables, and/or platform sections can be used.

Procedures for measuring the viscosity of slurry using the slump test are known in the art. Briefly, a 2 inch (or 5 cm) diameter tube is filled with slurry to a height of 4 inches (10 cm). Within 5 seconds from sampling the slurry from the manufacturing line, the slurry is released from the tube onto a flat, level surface and allowed to spread into a patty. When the slurry has stopped spreading, the widest diameter of the slurry patty is measured (in the case of non-circular (e.g., elliptical) slurry patty, the widest diameter of the slurry patty is averaged with the diameter of the slurry patty in the direction perpendicular to the widest diameter).

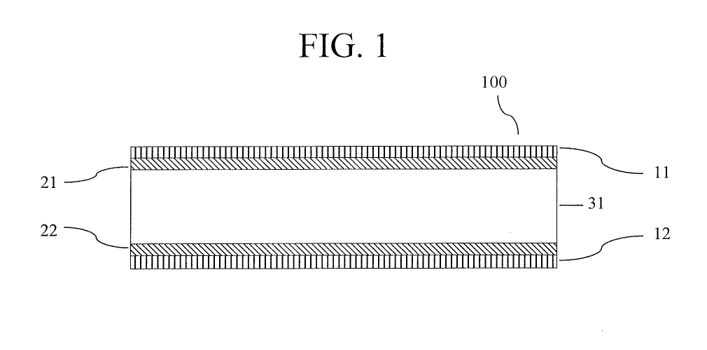

Embodiments of the present invention can be further described in view of the drawings. FIG. 1 schematically illustrates a one-layer core cementitious board 100. The board has a single core layer of a cementitious composition 31. The cementitious composition may be any cementitious composition suitable for making wallboard, e.g., cementitious compositions as described herein. The board has two skim coats 21 and 22, each of which are between the core 31 and two sheets of facer material 11 and 12. The skim coats and facer material can be any of those which are suitable, e.g., those as described herein.

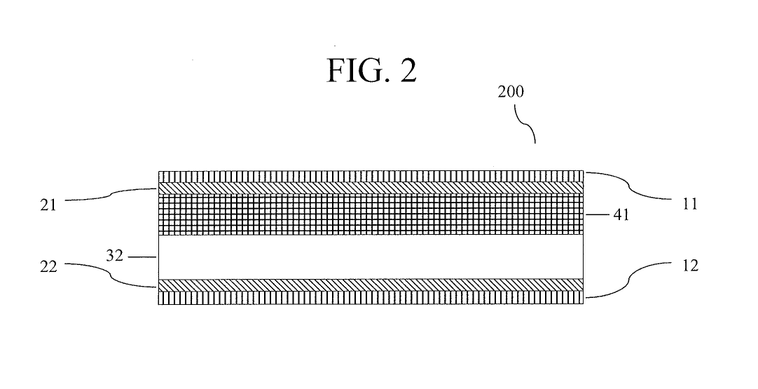

FIG. 2 schematically illustrates a two-layer core board 200 in accordance with an embodiment of the present invention. The board has facer material 11 and 12 and skim coats 21 and 22 as does the one-layer core board of FIG. 1. The skim coats and facer material can be any of those which are suitable, e.g., those as described herein. The core has two cementitious composition layers 32 and 41. The cementitious compositions may be any cementitious composition suitable for making wallboard, e.g., cementitious compositions as described herein. The core layer 32 can be the same or different as the core layer 31 of FIG. 1. The core layer 41 has a higher density than the density of core layer 32. The facer material 11 is the facing facer material of the board. Increased nail-pull resistance is realized when a nail punctures the facer material 11 and skim coat 21 and enters the core layer 41 of 200, as compared to when the nail punctures the facer material 11 and skim coat 21 and enters core layer 31 of 100, as in accordance with the present invention.

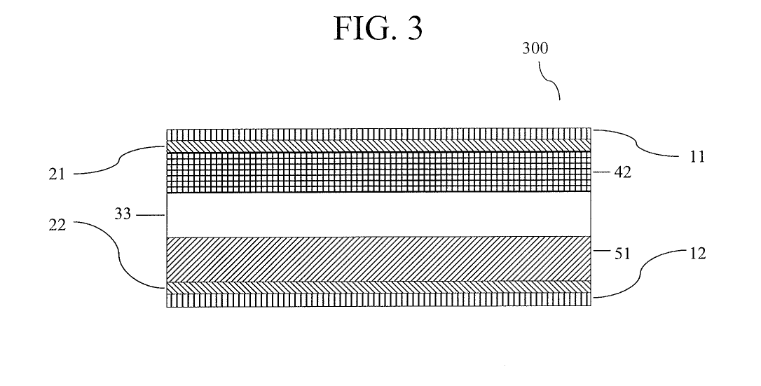

FIG. 3 schematically illustrates a three-layer core board 300 in accordance with an embodiment of the present invention. Similarly as in FIGS. 1 and 2, the board has facer material 11 and 12 and skim coats 21 and 22. The skim coats and facer material can be any of those which are suitable, e.g., those as described herein. The core has three cementitious composition layers 42, 33, and 51. The cementitious compositions may be any cementitious composition suitable for making wallboard, e.g., cementitious compositions as described herein. The core layer 33 can be the same or different as core layer 32 of FIG. 2 and/or core layer 31 of FIG. 1. The core layers 42 and 51 each have a density higher than the density of core layer 33. The core layers 42 and 51 can have the same density or different densities. Increased nail-pull resistance is realized when a nail punctures the facer material 11 and skim coat 21 and enters the core layer 42 of 300, as compared to when the nail punctures the facer material 11 and skim coat 21 and enters core layer 31 of 100, as in accordance with the present invention.

The following example further illustrates the invention but, of course, should not be construed as in any way limiting its scope.

### Example 1

This example demonstrates a gypsum board with multiple core layers having increased nail-pull resistance in accordance with the invention.

Lab bench boards (½″) were made using an 8″×8″×½″ plastic mold. The following were used for all boards: 39.6 lb/msf Caraustar Manila (facing paper) and 35.2 lb/msf USG Newslined (rear paper).

The core formulation was as follows: 500 g stucco, 500 g water, 10 g gypsum heat resistant accelerator, 1.5 g sodium trimetaphosphate, 3 g naphthalene sulfonate dispersant, 7.5 g pre-gelatinized corn starch.

A 50/50 mixture of Hyonic 25AS, and Hyonic PFM 33 soaps were used to generate foam.

Three different boards were made. The first one was a single-layer core board without foam addition. The second one also was a single-layer core board with 15 seconds foam addition during the mixing of the formulation. The third one was a two-layer core board with the layer beneath Manila paper having no foam (about ⅛″ in thickness) and the rest of the core having 15 seconds foam addition.

For the third board, the slurry for the second core layer was poured on the top of the first core layer about 10 minutes after the first core layer was poured on the back side of the Manila paper when the first core layer has already set hard.

The boards made were first dried in an oven at 350° F. for 10 minutes and in a 110° F. oven, overnight. After conditioning at 70° F., 50% RH for 24 hour, nail-pull strengths of the boards were tested per ASTM C473, Method B. The results are listed in Table 8.

TABLE 8
Board weight and nail pull strength

| | Dry weight | Equivalent | | Nail- | Nail | Nail |
|---|---|---|---|---|---|---|
| | of 8″ × 8″ | board weight | Density | pull | pull/ | pull/ |
| Board | lab board (g) | (lb/msf) | (lb/cuft) | (lbs) | Dry wt | Density |
| No | 435 | 2156 | 52 | 187.0 | 0.43 | 3.6 |
| foam | | | | | | |
| Foamed | 229 | 1135 | 27 | 58.9 | 0.26 | 2.2 |
| Two- | 261 | 1294 | 31 | 96.7 | 0.37 | 3.1 |
| layer | | | | | | |

Table 8 shows that the weight of the two-layer core board is 14% heavier than the foamed board, but the nail pull strength is 64% higher. The bonding between the two layers seems strong; no separation was noticed.

### Example 2

This example demonstrates additional exemplary gypsum boards with multiple core layers having increased nail-pull resistance in accordance with the invention.

Lab bench boards (½″) are made using an 8″×8″×½″ plastic mold. The following are used for all boards: 36.5 lb/msf Otsego Manila (facing paper) and 35.2 lb/msf Otsego Newslined (rear paper).

The core formulation is as follows: 500 g stucco, 500 g water, 0.5 g gypsum heat resistant accelerator, 2 g LC211 (acid-modified) starch, and pre-gelatinized corn starch as needed. A 60/40 mixture of Hyonic 25AS and Hyonic PFM 33 soaps is used to generate foam as needed.

For the boards with two layers, the slurry for the second core layer is poured on the top of the first core layer about 10 minutes after the first core layer is poured on the back side of the Manila paper when the first core layer is already set hard.

The boards made are first dried in an oven at 350° F. for 20 minutes and in a 110° F. oven overnight. After conditioning at 70° F., 50% RH for at least 16 hours, nail-pull strengths of the boards are tested per ASTM C473, Method B.

TABLE 9

| | 1st layer | 1st layer | 1st layer | 2nd layer | 2nd layer | 2nd layer |
|---|---|---|---|---|---|---|
| | Thickness | Foam | PG starch | Thickness | Foam | PG starch |
| Board | (in) | (sec) | (% stucco) | (in) | (sec) | (% stucco) |
| 1 | No | | | ½ | 0 | 0 |
| 2 | No | | | ⅓ | 5 | 0 |
| 3 | No | | | ¼ | 8 | 0 |
| 4 | No | | | ⅕ | 10 | 0 |
| 5 | No | | | ⅙ | 15 | 0 |
| 6 | No | | | 1/7 | 20 | 0 |
| 7 | 1/16 | 0 | 0 | 7/16 | 15 | 0 |
| 8 | ⅛ | 0 | 0 | ⅜ | 15 | 0 |
| 9 | 3/16 | 0 | 0 | 5/16 | 15 | 0 |
| 10 | ¼ | 0 | 0 | ¼ | 15 | 0 |
| 11 | No | | | ½ | 0 | 2 |
| 12 | No | | | ½ | 15 | 2 |
| 13 | ⅛ | 15 | 2 | ⅜ | 15 | 0 |
| 14 | ¼ | 15 | 2 | ¼ | 15 | 0 |
| 15 | ¼ | 8 | 0 | ¼ | 15 | 0 |

TABLE 10

| | | Dry wt | | Average | Nail | Nail |
|---|---|---|---|---|---|---|
| | Wet wt. | (70/50) | Density | nail pull | pull/ | pull/ |
| Board | (g) | (g) | (lb/cuft) | (lbs) | Dry wt | Density |
| 1 | 739 | 409.8 | 48.74 | 122.23 | 0.30 | 2.5 |
| 2 | 680.2 | 365.8 | 43.51 | 92.07 | 0.25 | 2.1 |
| 3 | 589 | 315 | 37.47 | 74.83 | 0.24 | 2.0 |
| 4 | 506.5 | 269.1 | 32.01 | 56.90 | 0.21 | 1.8 |
| 5 | 449.2 | 237 | 28.19 | 40.63 | 0.17 | 1.4 |
| 6 | 424.3 | 220.8 | 26.26 | 33.47 | 0.15 | 1.3 |
| 7 | 526.4 | 277.6 | 33.02 | 46.67 | 0.17 | 1.4 |
| 8 | 515.3 | 273 | 32.47 | 48.50 | 0.18 | 1.5 |
| 9 | 580.6 | 310 | 36.87 | 58.03 | 0.19 | 1.6 |
| 10 | 626.7 | 335 | 39.85 | 59.43 | 0.18 | 1.5 |
| 11 | 790.3 | 435.5 | 51.80 | 154.50 | 0.35 | 3.0 |
| 12 | 491.4 | 257.4 | 30.6 | 61.40 | 0.24 | 2.0 |
| 13 | 447.4 | 232.7 | 27.68 | 43.23 | 0.19 | 1.6 |
| 14 | 494.1 | 258.2 | 30.71 | 52.27 | 0.20 | 1.7 |
| 15 | 547 | 289.3 | 34.41 | 60.23 | 0.21 | 1.8 |

### Example 3

This example demonstrates additional exemplary gypsum boards with multiple core layers having increased nail-pull resistance in accordance with the invention.

Lab bench boards (½″) are made using an 8″×8″×½″ plastic mold. The following are used for all boards: 36.5 lb/msf Otsego Manila (facing paper) and 35.2 lb/msf Otsego Newslined (rear paper).

The core formulation is as follows: 500 g stucco, 600 g water, 1.5 g sodium trimetaphosphate, 7.5 g pre-gelatinized corn starch, 3 g DAXAD dispersant (Geo Specialty Chemicals, Lafayette, Ind.), air flow 3.0 lb/cuft, soap flow 0.2 gal/min. A 50/50 mixture of Hyonic 25AS and Hyonic PFM 33 soaps are used to generate foam as needed.

For the board with two layers, the slurry for the second core layer is poured on the top of the first core layer about 10 minutes after the first core layer is poured on the back side of the Manila paper when the first core layer is already set hard.

The boards made are first dried in an oven at 350° F. for 20 minutes and in a 110° F. oven overnight. After conditioning at 70° F., 50% RH for at least 16 hours, nail-pull strengths of the boards are tested per ASTM C473, Method B.

TABLE 11

| | 1st layer | 1st layer | 1st layer | 2nd layer | 2nd layer | 2nd layer |
|---|---|---|---|---|---|---|
| | Thickness | Foam | PG Starch | Thickness | Foam | PG Starch |
| Board | (in) | (sec) | (% stucco) | (in) | (sec) | (% stucco) |
| A | No | | | ½ | 10 | 1.5 |
| B | No | | | ½ | 8 | 1.5 |
| C | ⅛ | 0 | 1.5 | ⅜ | 10 | 1.5 |
| D | No | | | ½ | 0 | 1.5 |

TABLE 12

| | | Dry wt | | Average | Nail | Nail |
|---|---|---|---|---|---|---|
| | Wet wt. | (70/50) | Density | nail pull | pull/ | pull/ |
| Board | (g) | (g) | (lb/cuft) | (lbs) | Dry wt | Density |
| A | 509 | 277 | 32.95 | 71.75 | 0.26 | 2.2 |
| B | 572 | 306 | 36.40 | 108.37 | 0.35 | 3.0 |
| C | 572 | 309 | 36.75 | 124.57 | 0.40 | 3.4 |
| D | 748 | 413 | 49.06 | 169.10 | 0.41 | 3.4 |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Also, everywhere “comprising” (or its equivalent) is recited, the “comprising” is considered to incorporate “consisting essentially of” and “consisting of:” Thus, an embodiment “comprising” (an) element(s) supports embodiments “consisting essentially of” and “consisting of” the recited element(s). Everywhere “consisting essentially of” is recited is considered to incorporate “consisting of:” Thus, an embodiment “consisting essentially of” (an) element(s) supports embodiments “consisting of” the recited element(s). Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A board comprising:
a multi-layer core comprising (a) a first cementitious layer having a first density and a first thickness, and (b) a second cementitious layer having a second density and a second thickness;
wherein the first density is higher than the second density, and wherein the ratio of the first thickness to the second thickness is from about 1:1 to about 1:3.

2. A board comprising:
a multi-layer core comprising (a) a first cementitious layer having a first density and a first thickness and (b) a second cementitious layer having a second density and a second thickness, wherein the first density is higher than the second density, and wherein the nail pull resistance of the board according to ASTM C473, Method B is higher in comparison to board comprising a core consisting of the second cementitious layer having a thickness substantially equal to the first thickness plus the second thickness and a density substantially equal to the second density.

3. A board comprising:
a multi-layer core comprising (a) a first cementitious layer having a first density, and (b) a second cementitious layer having a second density; wherein the board core has a composite density based on all layers of the core; wherein the first density is higher than the second density; wherein the composite density is no more than about 45 lbs/ft³, and wherein the board has a minimum nail pull resistance according to ASTM C473, Method B of about 77 lbs of force.

4. The board of claim 1, wherein the multi-layer core further comprises (c) a third cementitious layer having a third density, wherein the third density is higher than the second density.

5. The board of claim 1, wherein one or more of the first or second cementitious core layers comprises set gypsum and, optionally, at least one additive selected from the group consisting of accelerator, retarder, enhancing agent, strength additive, or any combination thereof.

6. The board of claim 4, wherein one or more of the first, second, or third cementitious core layers comprises set gypsum and, optionally, at least one additive selected from the group consisting of accelerator, retarder, enhancing agent, strength additive, or any combination thereof.

7. The board of claim 1, wherein the first density is from about 35 lb/ft3 to about 70 lb/ft3 and the second density is from about 25 lb/ft3 to about 40 lb/ft3.

8. The board of claim 4, wherein the first density is from about 35 lb/ft3 to about 70 lb/ft3, the second density is from about 25 lb/ft3 to about 40 lb/ft3, and the third density is from about 35 lb/ft3 to about 70 lb/ft3.

9. The board of claim 4, wherein the nail pull resistance of the board according to ASTM C473, Method B is higher in comparison to board comprising a core consisting of the second cementitious layer having a thickness substantially equal to the sum of the thicknesses of the first, second, and third layers.

10. The board of claim 4, wherein the third cementitious layer has a third thickness, and wherein the ratio of the first thickness to the second thickness to the third thickness is from about 1:1:1 to about 1:3:1.

11. The board of claim 4, wherein the third cementitious layer has a third thickness, and wherein the ratio of (a) the sum of the first and third thicknesses to (b) the second thickness, is from about 1:1 to about 1:3.

12. The board of claim 1, further comprising two facer material, wherein the multi-layer core is disposed between the facing material.

13. The board of claim 4, wherein the second core layer is in-between the first core layer and the third core layer.

14. The board of claim 4, wherein the third density is about the same as the first density.

15. The board of claim 4, wherein the first cementitious layer is formed from the same composition as the third cementitious layer.

16. The board of claim 1, wherein the board has a weight of 1,500 lb/msf or less, wherein the board has a total thickness of about ½ inch, and wherein the board has a nail pull of at least 77 lbs according to ASTM C473, Method B.

17. A method of manufacturing layered board, the method comprising
providing facing material;
applying on the facing material a first cementitious composition having a first density, to form a first core layer;
allowing the first core layer to at least partially set; and
applying on the first core layer a second cementitious composition having a second density, to form a second core layer;
wherein the first density is higher than the second density, and
wherein the partial setting of the first layer conforms to the level of setting as described in ASTM C472 at 10.3.1 or until the first layer is sufficiently set so that wash-out of the first layer is substantially prevented when the second layer is applied.

18. The method of claim 17, further comprising applying a facer material on the second layer.

19. The method of claim 17, further comprising
allowing the second layer to partially set; and
applying on the second core layer a third cementitious composition having a third density to form a third core layer,
wherein the partial setting of the second layer conforms to the level of setting as described in ASTM C472 at 10.3.1 or until the second layer is sufficiently set so that wash-out of the second layer is substantially prevented when the third layer is applied.

20. The method of claim 19, wherein the third density is higher than the second density.
